(19) United States
(12) Patent Application Publication
(10) Pub. No.: US 2014/0324676 A1
(43) Pub. Date: Oct. 30, 2014

(54) Method for ordering and delivering an item

(71) Applicant: Viktor Palamarchuk, Wallington, NJ (US)

(72) Inventor: Viktor Palamarchuk, Wallington, NJ (US)

(21) Appl. No.: 13/986,391

(22) Filed: Apr. 28, 2013

(51) Int. Cl. G06Q 10/08; G06Q 20/22

(52) U.S. Cl. CPC G06Q 10/083; G06Q 20/22
USPC 705/39

(57) ABSTRACT

A methodology 10 which allows a user to order at least one item and have the ordered at least one item transported to a location specified by an address which is selected by the user.

### GENERAL BACKGROUND

1. Field of the Invention

The invention generally relates to a method for ordering and delivering an item and more particularly, to a method for ordering and delivering an item to a location having an address which is selected by the person or entity who orders the item, but which is not owned by that person or entity.

2. Background of the Invention

Frequently, an individual or entity desires to order an item from a store or establishment which is located in a country which is different from the country in which the ordering individual or entity resides. Some item providers will only provide the ordered item to a location which is in the country in which the item provide is located and even if the item provider will ship the ordered item to the country in which the ordering person or entity is located, it has been found to be oftentimes more convenient and cost effective to have the ordered item shipped to a place within the country in which the item provider is located.

There is a need for a business methodology which overcomes some or all of the previously delineated drawbacks of prior methodologies and which, by way of example and without limitation, allows for the shipment of an ordered product to an address in the country in which the product or item provider is located. The current inventions overcome these drawbacks and provide this benefit.

### SUMMARY OF THE INVENTION

It is a first non-limiting object of the present invention to provide a methodology for ordering and delivering an item which overcomes the various drawbacks associated with current and prior methodologies.

It is a second non-limiting object of the present invention to provide a methodology for ordering and delivering an item which overcomes the various drawbacks associated with current and prior methodologies and which allows a selected location having a selected address to be utilized and to which the ordered items are to be transported.

According to a first non-limiting aspect of the present invention, a method for ordering and delivering at least one item is provided. Particularly, the methodology includes the steps of acquiring an address from a person, wherein the acquired address specifies a certain location; ordering at least one item; having the at least one item shipped to the certain location which is specified by the acquired address; retrieving the shipped at least one item from the person; and paying the person for the use of the acquired address.

According to a second non-limiting aspect of the present invention, a method for ordering and delivering at least one item is provided and includes the steps of soliciting quotations from individuals, wherein each quotation includes a respective address and a respective amount of money requested to utilize the respective address; selecting one of the solicited quotations, effective to select one address and one amount of money and one of the individuals, wherein said selected on address specifies a certain location; ordering at least one item; having said ordered at least one item shipped to the certain location specified by the selected one address; paying the amount of money to the one of the individuals; and retrieving the at least one item from said one of the individuals.

These and other features, aspects and advantages of the present invention will become apparent to those of ordinary skill in the art by a reading the detailed description of the preferred embodiment of the invention, by reference to the claims, and by review of the included drawings.

### BRIEF DESCRIPTION OF THE DRAWINGS

FIG. 1 is a flow chart comprising a sequence of steps which cooperatively form the methodology of the preferred embodiment of the invention.

### DETAILED DESCRIPTION OF THE PREFERRED EMBODIMENT OF THE INVENTION

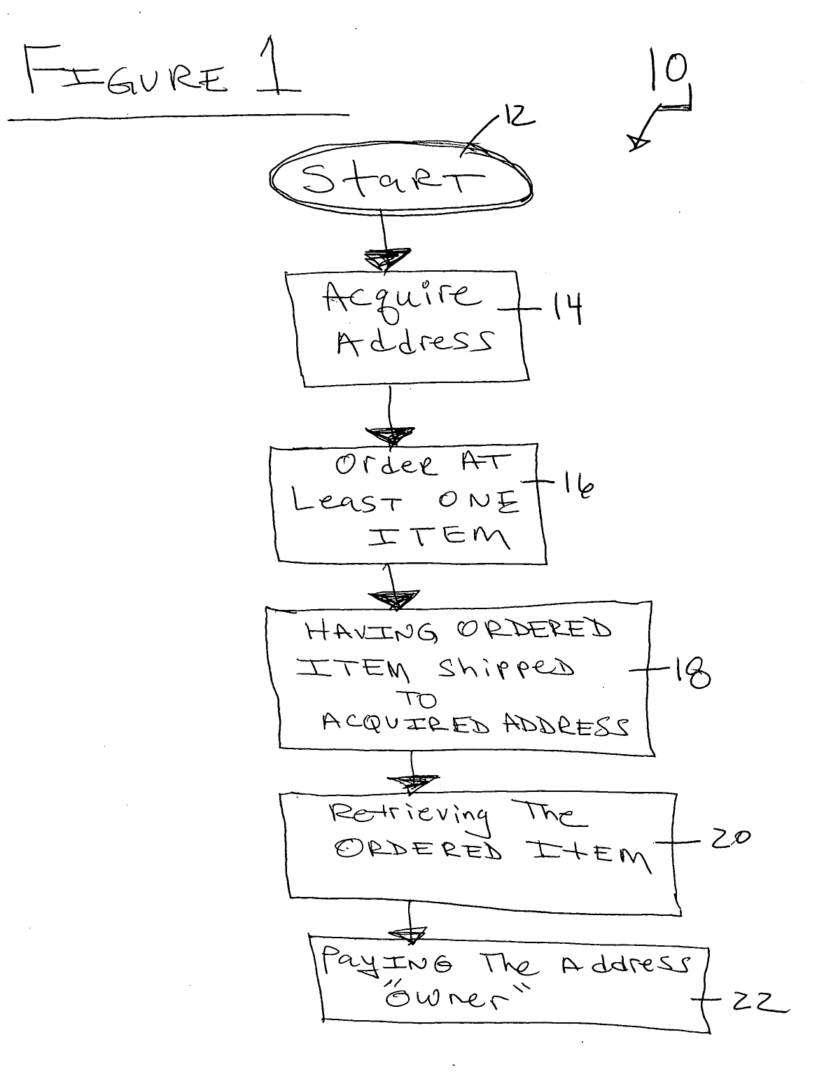

Referring now to FIG. 1, there is shown a flowchart 10 which comprises the methodology of the preferred embodiment of the invention.

Particularly, the flowchart 10 includes a first step 12 which denote the desire of the user to begin or start the methodology of flowchart 10. Step 12 is followed by step 14 in which an address is acquired and step 16 is followed by step 14 in which at least one item is ordered by the user. It should be understood that the acquired address specifies a unique location (e.g, a house or commercial building or post office box). Step 18 follows step 16 and, in this step 18, the user arranges to have the at least one ordered item shipped to the acquired address. Step 20 follows step 18 and , in this step 20, the at least one ordered item which has been shipped or otherwise transported to the acquired address is retrieved. Step 22 follows step 20 and, in this final step of the methodology , the address “owner” is paid for use of the address. The owner of the acquired address is at least one person or entity who has the legal right to have items shipped to the location specified by the acquired address.

In one non-limiting embodiment, the user resides within one country and the acquired address is associated with a location resident within a second country and typically the second country is also the location of the person or entity who is providing the at least one item.

In another non-limiting embodiment of the invention, the user in step 14 solicit, by the use of a global communications network, quotations from various individuals and entities and each quotation comprises an address within a certain country and a cost to use that address to which an order item or items may be transported. From these various received quotations, the use of the methodology 12 may select one of the quoted addresses to use in step 14.

It is to be understood that the present inventions are not limited to the exact scope or construction which has been delineated above, but that various changes and modifications may be made to the various embodiments without departing from the spirit and the scope of the following subjoined claims.

What is claimed is:

1) A method for ordering and delivering at least one item comprising the steps of acquiring an address from a person, wherein the acquired address specifies a certain location; ordering at least one item; having the at least one item shipped to the certain location which is specified by the acquired address; retrieving the shipped at least one item from the person; and paying the person for the use of the acquired address.

2) The method of claim 1 wherein said address is associated with a location in a first country and wherein the method for ordering is performed by a second person who is resident within a second country.

3) A method for ordering and delivering at least one item comprising the steps of soliciting quotations from individuals, wherein each quotation includes a respective address and a respective amount of money requested to utilize the respective address; selecting one of the solicited quotations, effective to select one address and one amount of money and one of the individuals, wherein said selected on address specifies a certain location; ordering at least one item; having said ordered at least one item shipped to the certain location specified by the selected one address; paying the amount of money to the one of the individuals; and retrieving the at least one item from said one of the individuals.
